(19) United States
(12) Patent Application Publication
(10) Pub. No.: US 2016/0011918 A1
(43) Pub. Date: Jan. 14, 2016

(54) APPLICATION DRIVING METHOD ACCORDING TO SITUATION CONDITION USING COMBINATION OF APPLICATION STATE CONDITIONS

(71) Applicant: Jeong Cheol HWANG, Seoul (KR)

(72) Inventor: Jeong Cheol HWANG, Seoul (KR)

(21) Appl. No.: 14/866,095

(22) Filed: Sep. 25, 2015

Related U.S. Application Data
(63) Continuation of application No. PCT/KR2013/005917, filed on Jul. 3, 2013.

(30) Foreign Application Priority Data
Mar. 29, 2013 (KR) 10-2013-0034302

(51) Int. Cl. G06F 9/54

(52) U.S. Cl. CPC G06F 9/54

(57) ABSTRACT

An application driving method according to a situation condition using a combination of application state conditions is provided. The method comprises setting a situation condition by combining state conditions of a condition application, selected among applications installed in a smart device, using a logic operator, thereby enabling a user to set the situation condition in accordance with the purpose and taste of the user by combining the applications installed in the smart device; monitoring by the smart device whether the condition application satisfies the state conditions and driving an operating application when the situation condition is “TRUE,” thereby automatically driving a customized application according to the states of the user. Furthermore, according to the present invention, a user can utilize various kinds of applications, and thus a user's satisfaction can be improved, contrary to using applications individually.

### CROSS-REFERENCE TO RELATED APPLICATION(S)

This application is a continuation application, claiming the benefit under §365(c), of an International application filed on Jul. 3, 2013 and assigned application number PCT/KR2013/005917, which claimed the benefit of a Korean patent application filed on Mar. 29, 2013 in the Korean Intellectual Property Office and assigned Serial number 10-2013-0034302, the entire disclosure of each of which is hereby incorporated by reference.

### TECHNICAL FIELD

The present invention generally relates to an application driving method. More particularly, the present invention relates to an application driving method according to a situation condition using a combination of application state conditions.

### BACKGROUND ART

With the rapid popularization of smart devices, various types of applications have been developed and are used on the smart devices. Although these applications are generally developed and manufactured by professional engineers, as ordinary persons' interest in developing applications has recently increased, and institutes or books for developing applications are helping such amateur enthusiasts develop their own applications, there is an increase in number of cases where an application developed by a layperson is registered in market.

Furthermore, users want to receive services according to their personal needs, including cases where a desired application is automatically driven if necessary. However, there is a limitation in that a service provider provides services in consideration of diverse user situations. Accordingly, although an existing application may be service provider-oriented, development of application by the service provider may not satisfy the demands of service consumers. Therefore consumers have stepped up efforts to develop diverse applications themselves.

However, not only it is difficult to directly develop an application at present, but also it requires a certain procedure to apply the application to smart devices and to use it. In particular, in order to use the developed application with other users together, the application needs to be registered in an application market, which causes various bothersome limitations. Accordingly, it is urgent to develop a technique for providing a service suitable for a user's situation without complex problems such as development or registration of the application.

### SUMMARY

Accordingly, the present invention has been made keeping in mind the above problems occurring in the related art, and an object of the present invention is to provide an application driving method according to a situation condition using a combination of application state conditions, which is capable of combining applications installed in a smart device to set a situation condition in order to be suitable for a purpose and preference of a user by combining state conditions of a conditional application, which is selected from among applications installed in the smart device, using a logical operator to set the situation condition, the application driving method being capable of automatically driving a customized application according to the user's situation, if the situation condition is true, when the smart device monitors whether the conditional application satisfies the state conditions, and being capable of improving user satisfaction, compared to a case where the applications are individually used, since the user may use various applications.

In order to accomplish the above object(s), the present invention provides an application driving method according to a situation condition using a combination of application state conditions by a smart device with a plurality of applications installed therein. The application driving method includes:

(1) providing a list of applications used for setting a situation condition and used to be driven among the applications installed in the smart device;

(2) receiving selections for at least one conditional application used for setting the situation condition and a driving application driven when the situation condition is true from among the applications included in the provided list;

(3) combining state conditions of the selected at least one conditional application by using a logical operator to set the situation condition;

(4) monitoring whether the at least one conditional application satisfies the state conditions to determine whether the situation condition is true; and

(5) driving the driving application, when the situation condition is true as the determination result.

In step (2), when no selection exists for the driving application, a pre-determined base application may be selected as the driving application.

The application driving method may further include (0) registering the application used for setting a situation condition and used to be driven before step (1), wherein in step (1), the list of the registered application is provided.

The application driving method may further include recommending an application used for setting a situation condition and used to be driven, which is uninstalled in the smart device before step (0).

The application driving method may further include recommending, by a smart device, a situation condition before step (2); and receiving a selection for any one of the recommended situation conditions, wherein in step (2), the at least one conditional application and driving application are selected according information on the selected situation condition, and in step (3), state conditions of the selected at least one conditional application are combined by using a logical operator to set as the selected situation condition.

The application driving method may further include receiving, by the smart device, a state condition of the at least one conditional application before step (3).

The application driving method may further include providing, by the smart device, a logical operator used for forming the situation condition and receiving a selection for the logical operator before step (3), wherein in step (3), the state conditions of the at least one conditional application are combined by using the selected logical operator to set the situation condition.

The application driving method may further include receiving to set, by the smart device, a driving condition of the driving application before step (4), wherein in step (5), the driving application is driven according to the set driving condition.

According to an application driving method according to a situation condition using a combination of application state conditions proposed herein, applications installed in a smart device may be combined to set a situation condition in order to be suitable for a purpose and preference of a user by combining state conditions of a conditional application, which is selected from among applications installed in the smart device, using a logical operator to set the situation condition, thus a customized application may be automatically driven according to the user's situation, if the situation condition is true, when the smart device monitors whether the conditional application satisfies the state condition, and since the user may use various applications, user satisfaction may be improved compared to a case where the applications are individually used.

### BRIEF DESCRIPTION OF DRAWINGS

FIG. 1 is a view illustrating a flow of an application driving method according to a situation condition using a combination of application state conditions according to an embodiment of the present invention;

FIG. 2 is a view illustrating an exemplary smart device for setting a situation condition in an application driving method according to a situation condition using a combination of application state conditions according to an embodiment of the present invention;

FIG. 3 is a view illustrating an exemplary smart device for setting a state condition of a conditional application in an application driving method according to a situation condition using a combination of application state conditions according to an embodiment of the present invention;

FIG. 4 is a view illustrating an exemplary smart device for checking a situation condition in an application driving method according to a situation condition using a combination of application state conditions according to an embodiment of the present invention;

FIG. 5 is a view illustrating an exemplary smart device in which a driving application is driven in an application driving method according to a situation condition using a combination of application state conditions according to an embodiment of the present invention;

FIG. 6 is a view illustrating a detailed flow of a process for registering an application in an application driving method according to a situation condition using a combination of state conditions of applications according to an embodiment of the present invention; and

FIG. 7 is a view illustrating a detailed flow of a process for recommending to set a situation condition in an application driving method according to a situation condition using a combination of application state conditions according to an embodiment of the present invention.

### DESCRIPTION OF THE REFERENCE NUMERALS IN THE DRAWINGS

10: APPLICATION
11: CONDITIONAL APPLICATION
12: DRIVING APPLICATION
20: LOGICAL OPERATOR
100: SMART DEVICE
S10: RECOMMEND APPLICATION
S20: REGISTER APPLICATION USED FOR SETTING AND DRIVING SITUATION CONDITION
S100: PROVIDE APPLICATION LIST
S150: RECOMMEND SITUATION CONDITION
S160: RECEIVE SELECTION FOR ANY ONE OF RECOMMENDED SITUATION CONDITIONS
S200: RECEIVE SELECTIONS FOR CONDITIONAL APPLICATION AND DRIVING APPLICATION
S250: RECEIVE STATE CONDITION OF CONDITIONAL APPLICATION
S260: PROVIDE LOGICAL OPERATOR AND RECEIVE SELECTION
S300: COMBINE STATE CONDITIONS OF CONDITIONAL APPLICATION USING LOGICAL OPERATOR TO SET SITUATION CONDITION
S350: RECEIVE TO SET DRIVING CONDITION OF DRIVING APPLICATION
S400: MONITOR WHETHER CONDITIONAL APPLICATION SATISFIES STATE CONDITION TO DETERMINE WHETHER SITUATION CONDITION IS TRUE
S500: DRIVE DRIVING APPLICATION WHEN SITUATION CONDITION IS TRUE

### DETAILED DESCRIPTION

Reference should now be made to the drawings, in which the same reference numerals are used throughout the different drawings to designate the same or similar components.

Hereinafter, embodiments of the present invention will be described in detail with reference to the accompanying drawings so that the present invention can be easily realized by those skilled in the art. Further, when it is determined that the detailed description of the related functions and constructions would obscure the gist of the present invention, the description thereof will be omitted. In addition, like reference numerals refer to elements having like functions and operations throughout the drawings.

In addition, if certain parts are described as being connected to other parts, they are not only directly connected to the other parts, but also indirectly connected to the other parts with any other device intervened therebetween. In addition, when an element is referred to as “comprising” or “including” a component, it does not preclude another component but may further include the other component unless the context clearly indicates otherwise.

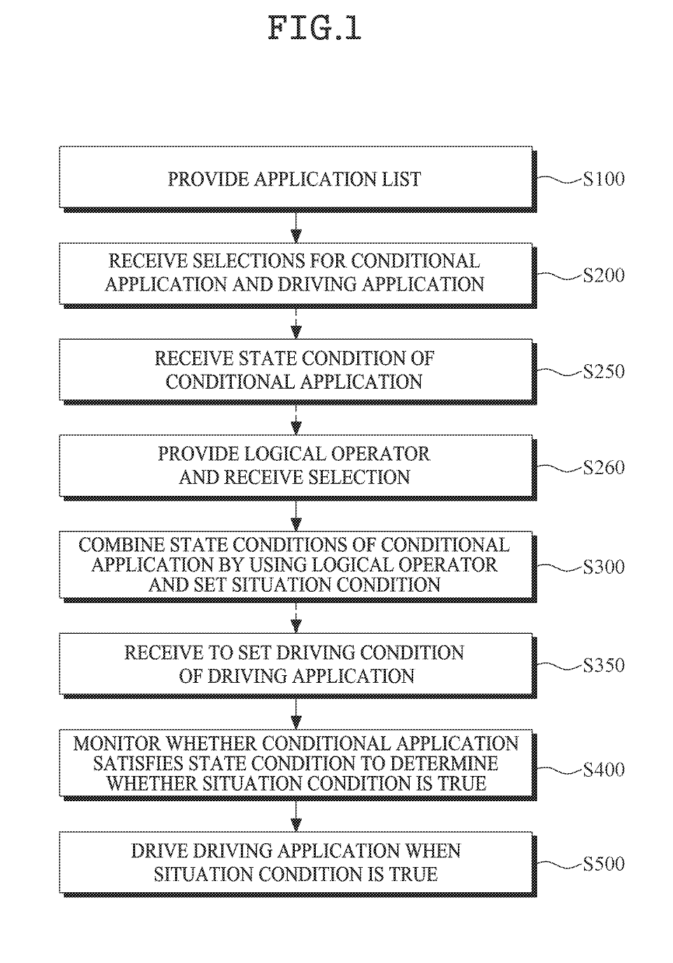

FIG. 1 is a view illustrating a flow of an application driving method according to a situation condition using a combination of state conditions of applications according to an embodiment of the present invention. As illustrated in FIG. 1, an application driving method according to a situation condition using a combination of application state conditions according to an embodiment of the present invention includes a step S100 for providing an application list, a step S200 for receiving selections of at least one conditional application and driving application, a step S300 for combining state conditions of the at least one conditional application using a logical operator to set a situation condition, a step S400 for monitoring whether the at least one conditional application satisfies the state conditions to determine whether the situation condition is true, and a step S500 for driving the driving application when the situation condition is true, and further includes a step S250 for receiving the state conditions of the at least one conditional application, a step S260 for providing the logical operator and receiving the selection, and a step S350 for receiving to set a driving condition of the driving application.

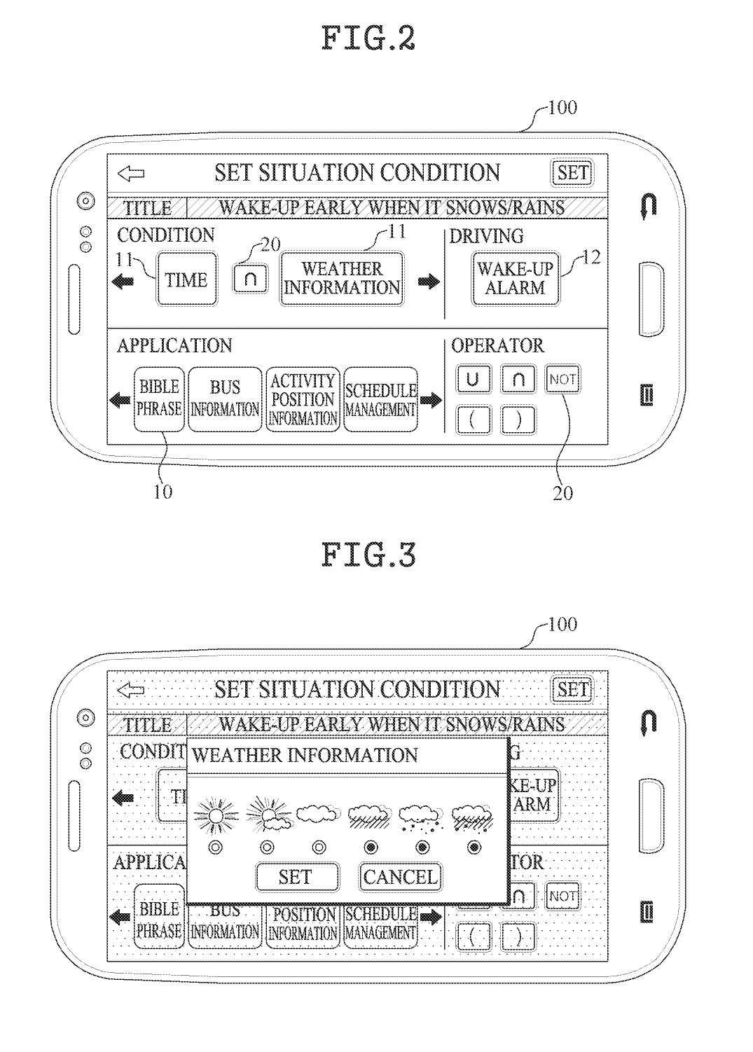

FIG. 2 is a view illustrating an exemplary smart device 100 for setting a situation condition in an application driving method according to a situation condition using a combination of application state conditions according to an embodiment of the present invention. An application driving method according to a situation condition using a combination of state conditions of an application 10 according to an embodiment of the present invention may be realized through a smart device 100 in which a plurality of applications 10 is installed. The smart device 100 is a product of which functions are not limited and may be changed or extend through the application 10, and includes a smartphone, smart note, tablet PC, smart camera, smart TV, or the like. However, the smart device 100 of the present invention is not limited to the terminal listed above, and a terminal, in which the plurality of applications 10 may be installed and combined to be driven in order to be suitable for a user's situation condition, may play a role of the smart device 100 of the present invention.

According to an application driving method according to a situation condition using a combination of state conditions of the application 10 according to an embodiment of the present invention, the situation condition may be set by combining state conditions of the at least one conditional application 11 that is selected from among the applications 10 installed in the smart device 100. The smart device 100 may provide an interface illustrated in FIG. 2 in order to set the situation condition, and a user of the smart device 100 may easily set the situation condition by using the provided interface. The smart device 100 may monitor whether the at least one conditional application 11 satisfies the state conditions to determine whether the situation condition, which is a combination of the state conditions, is true and may drive the driving application 12 when the situation condition is true.

Like this, the user of the smart device 100 may combine the applications 10 installed in the smart device 100 to set the situation condition to be suitable for a user's purpose and preference, and may allow the applications 10, which are customized according to the user's situation, to be automatically driven by driving the driving application 12 to notify that the situation condition is satisfied, when the user's situation condition is satisfied.

Hereinafter, each step of an application driving method according to a situation condition using a combination of state conditions of an application 10 according to an embodiment of the present invention will be described in detail.

In step S100, the smart device 100 may provide a list of the applications 10 used for setting and driving a situation condition among the applications 10 installed in the smart device 100. The smart device 100 has various applications 10 installed therein, and among the various applications 10, the list of the applications 100 available for setting the situation condition and for being driven may be provided to the user in step S100. For example, the list may be provided in a field of “application” illustrated in FIG. 2. At this point, whether the applications 100 are available for setting the situation condition and for being driven may be determined by the smart device 100 through a function search for the installed applications 10 or may be set by user's registration.

In step S200, the smart device 100 may receive a selection for at least one conditional application 11 to be used for the situation condition setting and a selection for the driving application 12 to be driven when the situation condition is true from among the applications 10 included in the list. In other words, in step S200, from among the applications 10 provided in step S100, the at least one conditional application 11 and the driving application 12 may be selected according to user selections. For example, as a screen illustrated in FIG. 2, the user may drag and drop an icon of the application 10 to a “condition” field to select the at least one conditional application 11, and drag and drop that to a “driving” field to select the driving application 12. At this point, the at least one conditional application 11 may be an application for forming the situation condition through combination by the logical operator 20, and the driving application 12 may be an application that plays a role for notifying the user of the situation condition being true and is required to be driven according to the situation condition.

Furthermore, in step S200, when the driving application 12 is not selected, a pre-determined base application 10 may be selected as the driving application 12. At this point, the pre-determined base application 10 may be a message transmission application 10 or the like. In other words, when the user does not select a separate driving application, the user may be notified that the situation condition is true through a message, such as a push message.

In step S250, the smart device 100 may receive the state condition of the at least one conditional application 11. At this point, the state condition may be a condition for collecting information on a current state or the like by using a function of the at least one conditional application 11. For example, when the at least one conditional application 11 is a weather information application 10, the state condition may be “rain”, and when the at least one conditional application 11 is a position information application 10, the state condition may be “current position”.

FIG. 3 is a view illustrating an exemplary smart device 100 for setting a state condition in an application driving method according to a situation condition using a combination of application state conditions according to an embodiment of the present invention. As illustrated in FIG. 3, in step S250 of an application driving method according to a situation condition using a combination of state conditions of an application 10 according to an embodiment of the present invention, the state condition of the weather information application 10, which is a type of the at least one conditional application 11, may be input as “rain, snow, or rain or snow”, or the like. In other words, in a situation condition setting screen illustrated in FIG. 2, when the user touches or clicks the weather information application 10 of the at least one conditional application 11, only a state condition setting screen as illustrated in FIG. 3 may be output to allow the user to easily set the state condition for a corresponding conditional application 11. As illustrated in FIG. 3, the state condition may be selected in plurality, and when the selected state conditions are not satisfied at the same time, the state condition may be set through a logical OR (i.e. union).

Furthermore, according to an embodiment, each condition application 11 may be executed to set the state condition in advance. In this case, step S250 may be automatically processed by receiving a state condition preset for each conditional application 11 from a corresponding conditional application 11.

In step S260, the smart device 100 may provide the logical operator 20 used for forming the situation condition and receive a selection by the logical operator 20. At this point, as an element for configuring a logical expression, the logical operator 20 may include a logical AND (or ∩), logical OR (or ∪), or logical NOT, and may further include a logical exclusive-OR (i.e. XOR). In addition, in step S260, elements may be further provided which are necessary for configuring the logical expression, such as parentheses that represent a calculation sequence of the logical expression. For example, in the situation condition setting screen illustrated in FIG. 2, the logical operator 20 may be selected by drag-and-dropping any one of the logical operators 20 to the condition field.

In step S300, the smart device 100 may combine the state conditions of the selected at least one conditional application 11 by using the logical operator 20 to set the situation condition. In other words, the smart device 100 may set the situation condition by combining the state conditions set for the at least one conditional application 11 selected in step S200 through the logical operator 20, and at this point, may set the situation condition by performing the combination through the logical operator 20 selected in step S260. Furthermore, in step S300, the situation condition may be set by inputting a title thereof. When the title is input to set the situation condition and stored, the user may easily grasp which situation condition is thereafter and edit it.

For example, from the example illustrated in FIG. 2, when the state condition of the at least one conditional application 11 is set to be “1 hour before wake-up time” for the time application 11, and “snow, rain, or snow or rain” for the weather information application 11, since the time and weather information applications 11 are combined by a logical AND (i.e. ∩) among the logical operators 20, the situation condition may be set to be “the weather is snow, rain, or snow or rain at one hour before the wake-up time”. In FIG. 2, since the wake-up alarm application 12 is selected as the driving application 12 under this situation condition, when this situation condition is satisfied, the wake-up alarm application 12 may be driven.

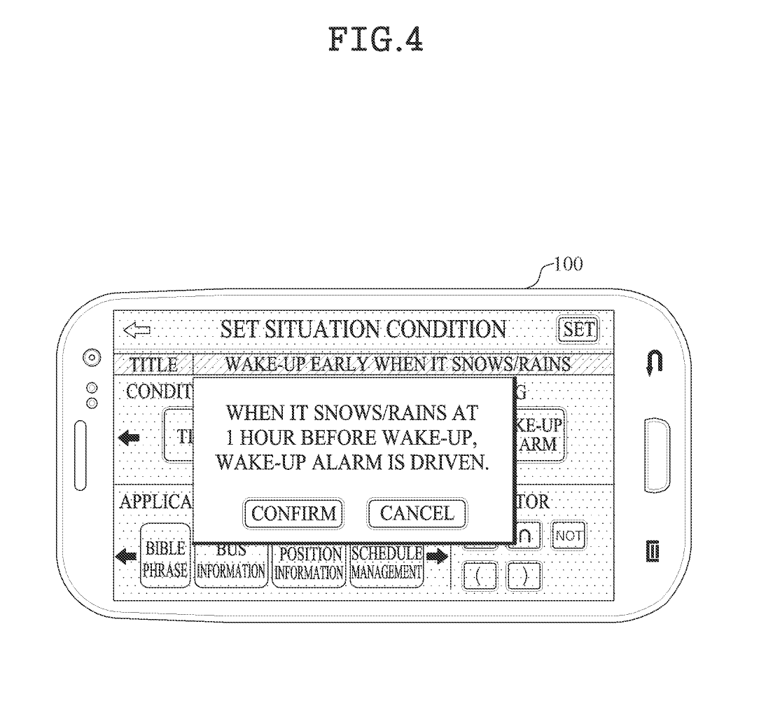

FIG. 4 is a view illustrating an exemplary smart device 100 for setting a situation condition in an application driving method according to a situation condition using a combination of application state conditions according to an embodiment of the present invention. As illustrated in FIG. 4, in step S300 of an application driving method according to a situation condition using a combination of state conditions of an application 10 according to an embodiment of the present invention, the situation condition generated by the combination of state conditions of the at least one conditional application 11 may be output as a popup message or the like to allow the user to check it. When the user erroneously selects the application 10 or logical operator 20 to set the situation condition, since the application 10 may be driven at an unwanted time, as illustrated in FIG. 4, the situation condition may be set after user's checking.

In step S350, the smart device 100 may receive to set a driving condition of the driving application 12. The driving condition may be a condition for setting a driving state of the driving application 12, when the situation condition set in step S300 is satisfied to drive the driving application 12. For example, in the above described example, an alarm sound of the wake-up alarm or whether to repeat the wake-up alarm may be the driving condition. In addition, for a bible phrase application 10, the driving condition may be to allow a bible passage to be connected from a section part having been read before or to allow an arbitrary section to be presented.

In step S400, the smart device 100 may monitor whether the at least one conditional application 11 satisfies the state condition to determine whether the situation condition is true. In other words, the smart device 100 may collect information related to the set state conditions from the at least one conditional application 11 to monitor, and when a predetermined state condition is “True”, may determine that the situation condition is true.

For example, in the example illustrated in FIG. 2, the set wake-up time information may be obtained from the wake-up alarm application 10 and current time information may be collected from the time application 11. When the state condition for the time application 11 is one hour before the wake-up time and the set wake-up time information obtained from the wake-up alarm application 10 is 7, whether to be 6 am may be monitored by obtaining the current time information from the time application 11 at a pre-determined time interval. When it is 6 am and the state condition for the time application 11 is “True”, it is required to determine whether the state condition for the weather information application 11, which is combined by a logical AND, is “True”. Accordingly, the current weather information is obtained from the weather information application 11 at 6 am and when the current weather information is snow, rain, or snow or rain, the smart device 100 may determine that the situation condition, which is combined by logical ANDing of two conditional applications 11, is true.

In step S500, as the determination result in step S400, when the situation condition is true, the smart device 100 may drive the driving application 12. At this point, in step S500, the smart device 100 may drive the driving application 12 according to the driving condition set in step S350. However, when there is not the set driving condition, the smart device 100 may drive the driving application 12 in an initial state that is typically output from executions of the driving application 12.

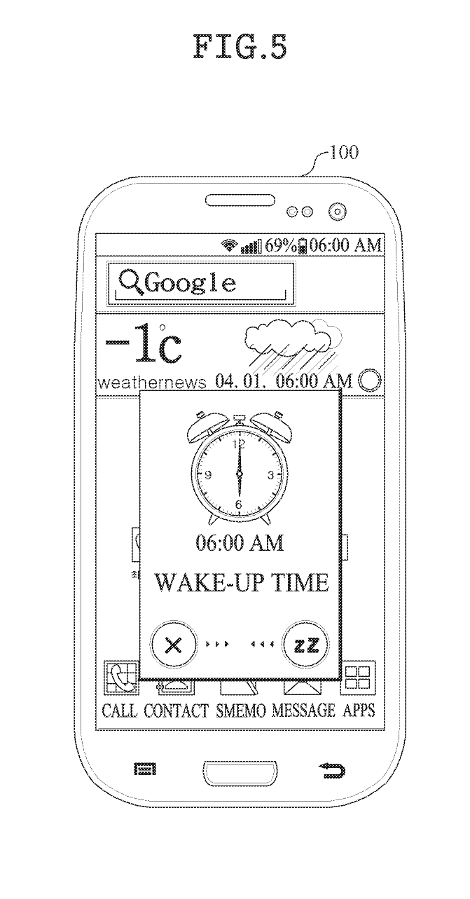

FIG. 5 is a view illustrating an exemplary smart device 100 in which the driving application 12 is driven in an application driving method according to a situation condition using a combination of application state conditions according to an embodiment of the present invention. As illustrated in FIG. 5, in step S500 of an application driving method according to a situation condition using a combination of application state conditions according to an embodiment of the present invention, the wake-up alarm application 12, which is the driving application 12, may be driven, when the current weather information is rain at 6 am and the situation condition is true. In other words, since a wake-up time is internally set at 7 am with the wake-up application 12, the wake-up alarm may ring at 7 am. However, when it rains or snows, since the situation condition is true, the wake-up alarm may ring at 6 am. At this point, according to the driving information set in step S350, an alarm sound, which is different from the sound that rings at 7 am, may be output and when the alarm is terminated, the alarm may repeatedly ring for the predetermined number of times.

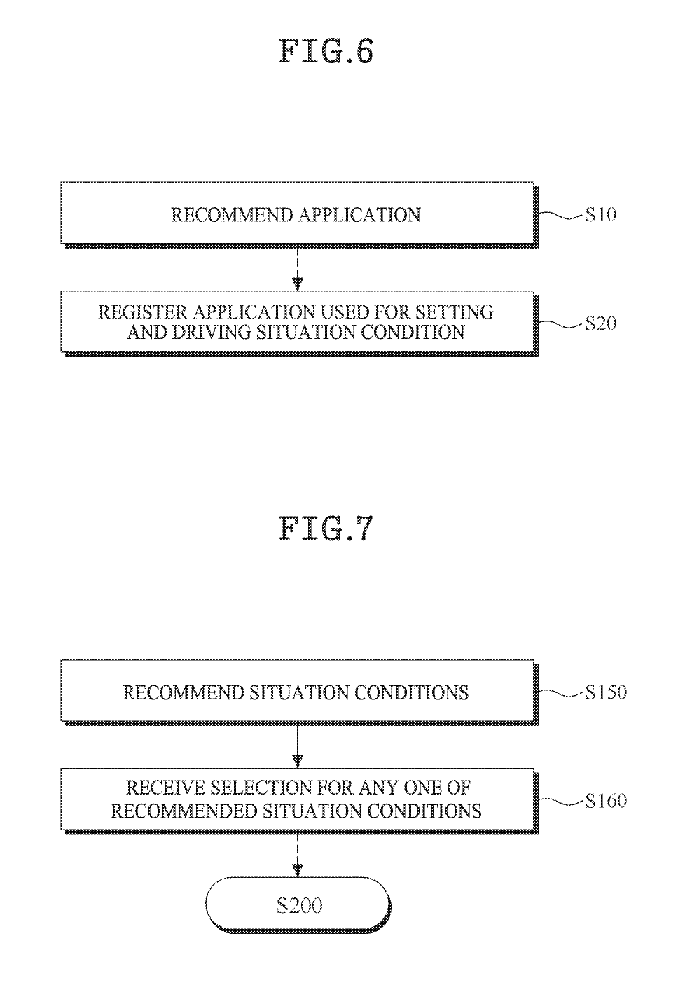

FIG. 6 is a view illustrating a detailed flow of a process for registering an application 10 in an application driving method according to a situation condition using a combination of state conditions of applications 10 according to an embodiment of the present invention. As illustrated in FIG. 6, in an application driving method according to a situation condition using a combination of state conditions of applications 10 according to an embodiment of the present invention, the applications 10 may be registered through step S20 for registering the application 10 used for setting a situation condition and used to be driven, and step S10 for recommending an application 10 may be further included.

In step S10, the smart device 100 may recommend the applications 10 used for setting a situation condition and used to be driven, which is uninstalled in the smart device 100. In other words, through the application driving method according to a situation condition using a combination of state conditions of applications according to an embodiment of the present invention, the application may be recommended in order to provide a more efficient driving service for a customized application 10 according to the user's situation. Through step S10, more various applications 10 may be used and application transactions may be activated.

In step S20, the smart device 100 may register the application 10 used for setting a situation condition and used to be driven. In step S100, a list of the applications 10 registered in step S20 may be provided. At this point, in step S20, the smart device 100 may automatically search the applications 10 installed therein for the application 10 necessary for setting and driving the situation condition, but according to an embodiment, the user may select a necessary application 10 and register it.

FIG. 7 is a view illustrating a detailed flow of a process for recommending and setting a situation condition in an application driving method according to a situation condition using a combination of application state conditions according to an embodiment of the present invention. As illustrated in FIG. 7, in the application driving method according to a situation condition using a combination of application state conditions according to an embodiment of the present invention, a situation condition is recommended and the recommended situation condition may be set through step S150 for recommending the situation condition and step S160 for receiving a selection for any one of the recommended situation conditions.

In step S150, the smart device 100 may recommend a situation condition. In other words, before the user directly selects the at least one conditional application 11, driving application 12, logical operator 20, and the like, the smart device 100 may recommend in advance a pre-combined situation condition to allow the user to use it. The user may feel difficulty in selecting the at least one conditional application 11 to combine them through the logical operator 20 in order to set a desired situation condition. Accordingly, in step S150, a previously combined situation condition may be recommended to allow the user to easily set the situation condition.

In step S160, the smart device 100 may receive a selection for any one of the recommended situation conditions. In other words, the user, who browses the recommended situation conditions, may select to use any one thereof. In step S200, the at least one conditional application 11 and the driving application 12 are selected according to information on the situation condition selected in step S160, and in step S300, state conditions of the selected at least one conditional application 11 are combined by using the logical operator 20 to be set as the selected situation condition. At this point, the state condition of the at least one conditional application 11 is changeable to be suitable for the user and accordingly the user may change the recommended situation condition to a desired situation condition and use it.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of driving an application according to a situation condition using a combination of application state conditions by a smart device with a plurality of applications installed therein, the method comprising:
(1) providing a list of applications used for setting a situation condition and used to be driven among the applications installed in the smart device;
(2) receiving selections for at least one conditional application used for setting the situation condition and a driving application driven when the situation condition is true from among the applications included in the provided list;
(3) combining state conditions of the selected at least one conditional application by using a logical operator to set the situation condition;
(4) monitoring whether the at least one conditional application satisfies the state conditions to determine whether the situation condition is true; and
(5) driving the driving application, when the situation condition is true as the determination result.

2. The method of claim 1, wherein in step (2), when no selection exists for the driving application, a pre-determined base application is selected as the driving application.

3. The method of claim 1, further comprising:
(0) registering the application used for setting a situation condition and used to be driven before step (1),
wherein in step (1), the list of the registered application is provided.

4. The method of claim 3, further comprising:
recommending an application used for setting a situation condition and used to be driven, which is uninstalled in the smart device before step (0).

5. The method of claim 1, further comprising:
recommending, by a smart device, a situation condition before step (2); and
receiving a selection for any one of the recommended situation conditions,
wherein in step (2), the at least one conditional application and driving application are selected according to information on the selected situation condition, and
in step (3), state conditions of the selected at least one conditional application are combined by using a logical operator to set as the selected situation condition.

6. The method of claim 1, further comprising:
receiving, by the smart device, a state condition of the at least one conditional application before step (3).

7. The method of claim 1, further comprising:
providing, by the smart device, a logical operator used for forming the situation condition and receiving a selection for the logical operator before step (3),
wherein in step (3), the state conditions of the at least one conditional application are combined by using the selected logical operator to set the situation condition.

8. The method of claim 1, further comprising:
receiving to set, by the smart device, a driving condition of the driving application before step (4),
wherein in step (5), the driving application is driven according to the set driving condition.
